(19) United States
(12) Patent Application Publication
(10) Pub. No.: US 2018/0075383 A1
(43) Pub. Date: Mar. 15, 2018

(54) GEOLOCATING ENTITIES OF INTEREST ON GEO HEAT MAPS

(71) Applicant: THE DUN & BRADSTREET CORPORATION, Short Hills, NJ (US)

(72) Inventors: Steven Richard Fogel, Randolph, NJ (US); Rakesh Kumar Malhotra, Somerset, NJ (US); Sathyanarayana Elarpu Mahaganapathy, Randolph, NJ (US); Dinu Mathai, Ernakulam (IN); Deepak Shantaram Giriraddi, New Jersey, NJ (US)

(21) Appl. No.: 15/703,420

(22) Filed: Sep. 13, 2017

Related U.S. Application Data
(60) Provisional application No. 62/394,556, filed on Sep. 14, 2016.

(51) Int. Cl. G06Q 10/06; G06T 11/60; G06T 11/20

(52) U.S. Cl. CPC G06Q 10/0635; G06T 11/001; G06T 11/206; G06T 11/60

(57) ABSTRACT

A geographic heat map has a first layer having a map of countries; a second layer superimposed upon and in alignment with the first layer including locations of various entities on the map; and a third layer superimposed on the second layer and in alignment with the first layer, the third layer having information concerning risk in the countries displayed in the first layer. The map can be a world map, and the third layer can display data representative of at least one of risk of corruption and risk of money laundering in the countries on the map. A system, a method and a computer readable non-transitory storage medium for generating the geographic map are disclosed.

This application claims priority from and the benefit of U.S. provisional patent application Ser. No. 62/394,556, filed on Sep. 14, 2016, which is incorporated herein by reference, in its entirety, for all purposes.

### BACKGROUND OF THE DISCLOSURE

### 1. Field of the Disclosure

The present disclosure relates to location and risk and their visualization on a so called heat map with multiple superimposed layers. More particularly, it relates to visualizing location and risk based on a variety of parameters relating to a business, including principals, shareholders, related parties, linkage, money laundering and corruption.

### 2. Description of the Related Art

There are a variety of applications that consider risks associated with business activity. The most well know company in this field is The Dun & Bradstreet Corporation. Through a suite of products and services, Dun & Bradstreet enables business to obtain information on other businesses and assess the risk of doing business with a company or an individual, through tools such as predictive analytics, delinquency prediction, total loss predictions and supply chain information. The Dun & Bradstreet Corporation provides commercial data to businesses on credit history, business-to-business sales and marketing, risk exposure, lead scoring and social identity matching. The databases that are used to provide these services include entries on adverse media attention, litigation and information concerning company shareholders, principals and related companies.

While these tools are exceedingly useful, they do not provide the visual analysis required to warn businesses of the risks due to corruption or money laundering in certain part of the world, and where that risk is located.

There exists a need for a system and a method to provide a quick and reliable way of assessing additional business risk due to adverse business practices throughout the world.

### SUMMARY OF THE DISCLOSURE

In accordance with the disclosure, there is provided a geographic map, comprising a first layer having a map of countries; a second layer superimposed upon and in alignment with the first layer including locations of various entities on the map; and a third layer superimposed on the second layer and in alignment with the first layer, the third layer having information concerning risk in the countries displayed in the first layer.

The entities displayed in the second layer can include at least one of a business, and principals, shareholders, related entities and corporate linkages of the business. For any business entity, data can be on customers, business structure including related entities, suppliers, adverse media information, litigation information, and data concerning principals, shareholders and related companies.

A graphical user interface allows a user to select a display of data representative of business risk for a business entity by one of principals, shareholders, related entities and corporate linkages.

The third layer can be representative of risk in a given year. A graphical user interface can be provided for use in selecting which year is to be displayed. The graphical user interface can include a drop down menu for selecting which year is to be displayed.

The third layer can have features representative of business risk due to at least one of corruption and money laundering in countries displayed on the map. The geographic map can be configured as a world map.

The disclosure is also directed to a display device configured for displaying a geographic map having a structure and features as discussed above. The display device can be connected to a computer, comprising a processor; a memory for storing instructions for the processor to perform steps of assembling data representative of the first layer, the second layer and the third layer; and converting the assembled data into the geographic map so that the map is placed on the display.

The disclosure is also directed to a method for generating a geographic map, comprising providing a first layer having a map of countries; providing a second layer superimposed upon and in alignment with the first layer including locations of various entities on the map; and providing a third layer superimposed on the second layer and in alignment with the first layer, the third layer having information concerning risk in the countries displayed in the first layer.

The entities displayed in the second layer include at least one of a business, and principals, shareholders, related entities and corporate linkages of the business. For any business entity, data can be on customers, business structure including related entities, suppliers, adverse media information, litigation information, and data concerning principals, shareholders and related companies.

The method can further comprise providing a graphical user interface on the map to allow a user to select a display of data representative of business risk for a business entity by one of principals, shareholders, related entities and corporate linkages. The third layer is representative of risk in a given year, and a graphical user interface can be provided for use in selecting which year is to be displayed. The graphical user interface can include a drop down menu for selecting which year is to be displayed.

The third layer can have features representative of business risk due to at least one of corruption and money laundering in countries displayed on the map. The map can be configured as a world map.

In accordance with another aspect of the disclosure, a computer readable non-transitory storage medium storing instructions of a computer program which when executed by a computer system having a processor and a memory, results in performance of steps for providing a geographic map, comprising providing a first layer having a map of countries; providing a second layer superimposed upon and in alignment with the first layer including locations of various entities on the map; and providing a third layer superimposed on the second layer and in alignment with the first layer, the third layer having information concerning risk in the countries displayed in the first layer.

The third layer can have features representative of business risk due to at least one of corruption and money laundering in countries displayed on the map.

Thus, in accordance with one preferred embodiment, the present disclosure provides a geographic map of the world or smaller parts thereof. Symbols indicative of locations for various business entities are superimposed on the map. The symbols may be used to bring up data on the various business entities of the type described above. Also superimposed on the map are color overlays representative of data obtained from an anti-money laundering database and/or a corruption index. This data is allocated by country, so that the user can draw inferences from the combination of data concerning the business organization of interest and data concerning the money laundering or corruption associated with a given country in which the business may be located or in which the business may have a branch or subsidiary.

The disclosure is also directed to a system for generating a geographic heat map, comprising a source for acquiring geographic data including data required to generate a map of countries; a processor for generating a first layer of a display in accordance with the geographic data; a source for acquiring entity data concerning entities and their locations with respect to said locations on said map; the processor using the entity data to generate a second layer superimposed upon and in alignment with the first layer including locations of various entities on the map; and a source for acquiring business risk data; the processor generating a third layer superimposed on the second layer and in alignment with the first layer, the third layer using the business risk data to display information concerning risk in the countries displayed in the first layer.

### BRIEF DESCRIPTION OF THE DRAWINGS

FIG. 1 is a diagram of the layers displayed on a map produced in accordance with the disclosure.

FIG. 1A is a flow chart of how data is acquired and the layers are produced in the diagram of FIG. 1.

FIG. 1B is a representation of a system architecture used to implement the method and system disclosed herein.

FIG. 2A is a plan view of an actual map produced in accordance with the disclosure, showing money laundering risk.

FIG. 2B is a plan view of an actual map produced in accordance with the disclosure, showing corruption risk.

FIG. 2C is an example of a screen display, including a drop down menu, for use with the displays of FIGS. 2A and 2B.

FIGS. 3 is a block diagram of a computer system used to generate the maps of FIG. 2A and FIG. 2B.

A component or a feature that is common to more than one drawing is indicated with the same reference number in each of the drawings.

### DETAILED DESCRIPTION OF THE PREFERRED EMBODIMENTS

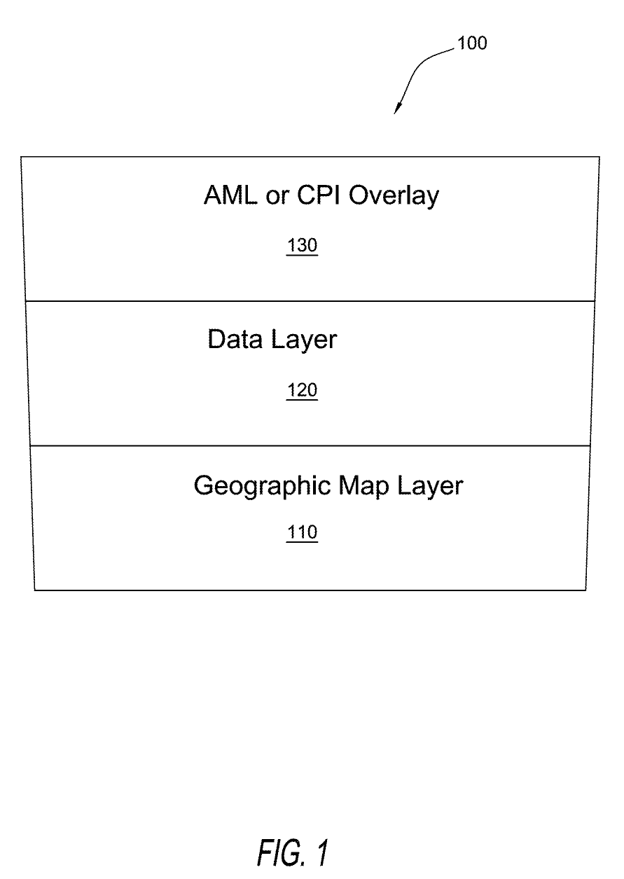

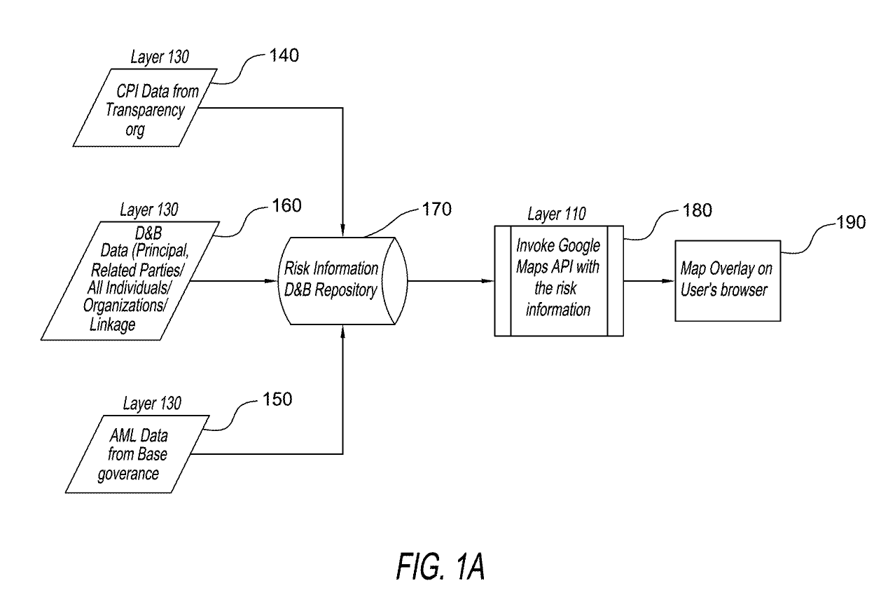

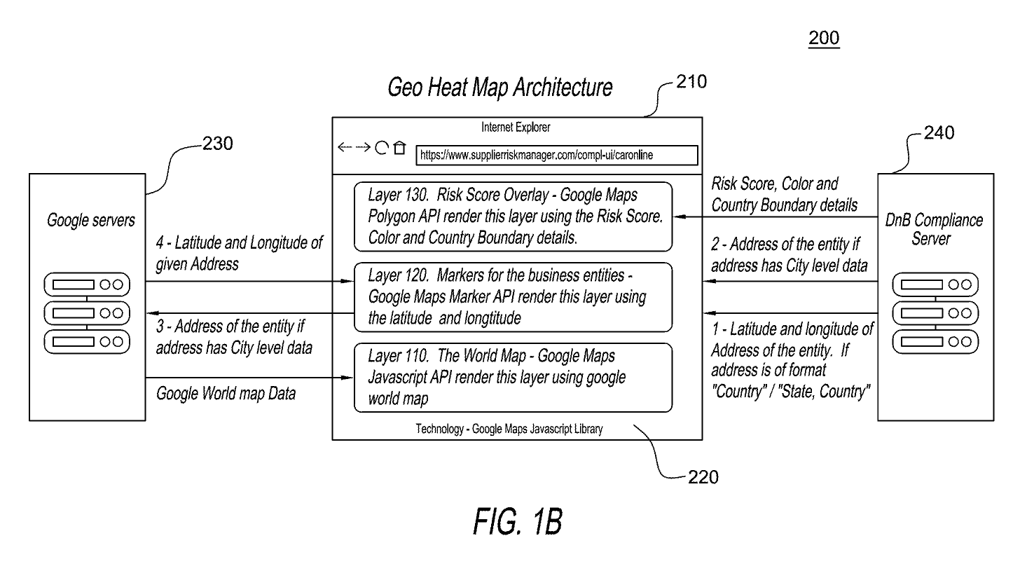

FIG. 1 shows the layers of a map 100 used to display the various layers of data to allow a user to combine data on businesses, of the type collected by The Dun & Bradstreet Corporation and data concerning the extent of risk of doing business due to money laundering or corruption in a given country in which a business organization, or a part of that organization may be located.

In general, to provide the layers discussed below, a geographic data source such as, for example, the Google-maps Javascript library and the features provided by the Google-maps library can be used. Country boundary (latitude and longitude) information for all the Country and the States of US and the provinces of Canada is available for the user interface layers, as discussed below.

A first layer 110 of map 100 is a geographic map layer (preferably of the world), or a part of the world. First layer 110 may be generated by using the Google Maps API. It will be understood that other mapping technologies can be used, but that for purposes of description herein, reference is made to Google Maps, or the Google Maps API.

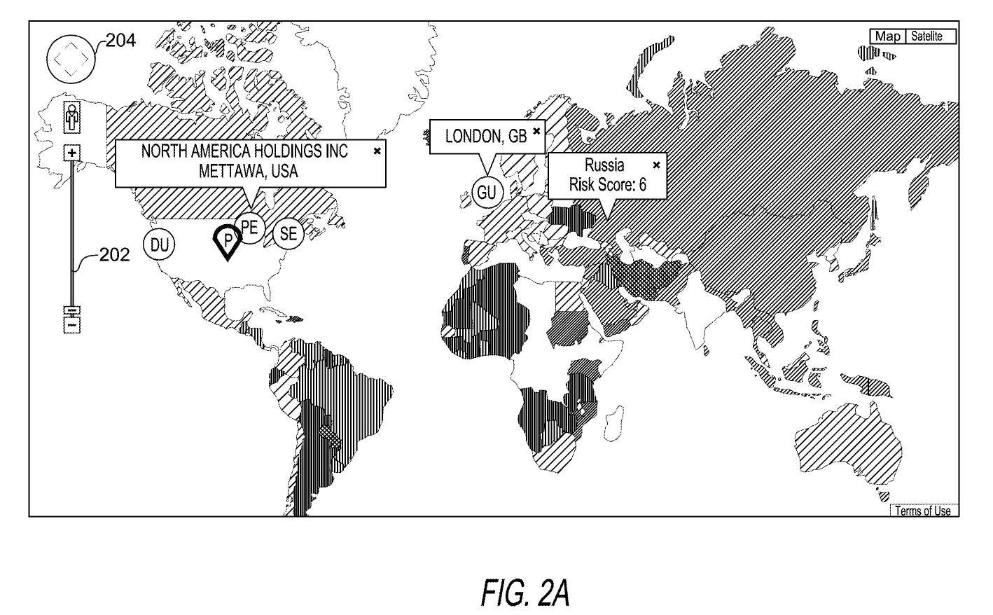

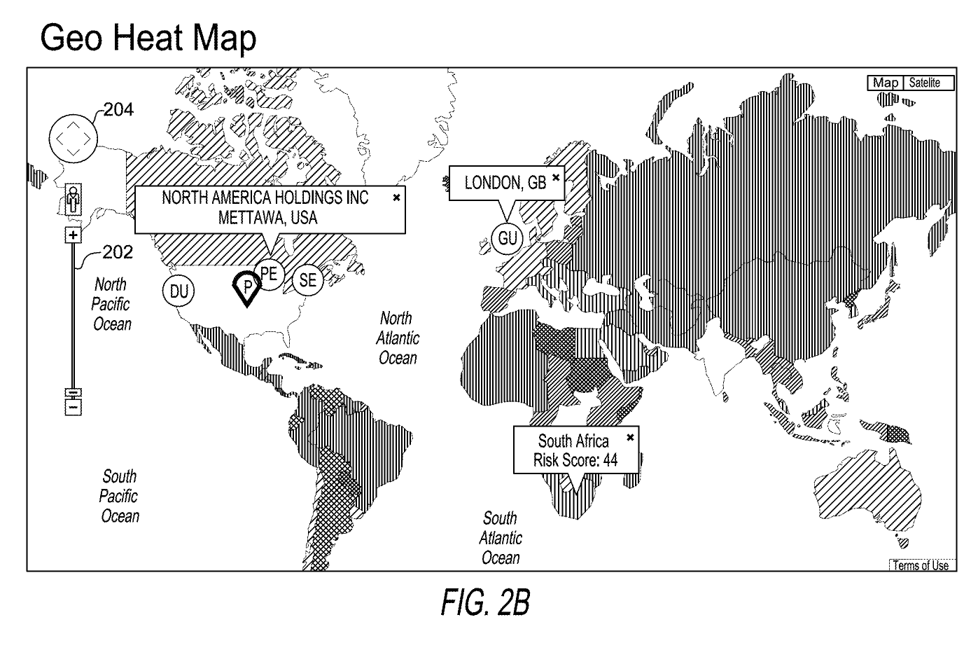

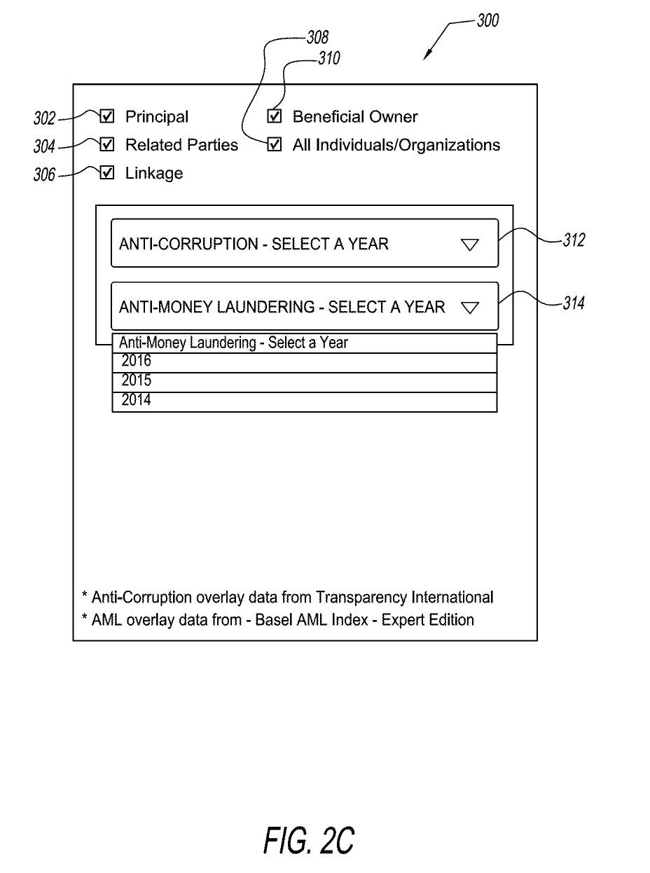

A second layer 120 is a data layer that includes business data of the type accumulated by, for example, The Dun & Bradstreet Corporation. This data can include, for any business entity, data on a business entity such as customers, business structure including related entities, suppliers, adverse media information, litigation information, and data concerning principals, shareholders and related companies. This data can be accessed as explained below with respect to FIG. 2.

Continuing with respect to FIG. 1, a third layer 130 can be an overlay (a superposition) of, in general, one of an anti-money laundering (AML) score or a corruption index score (CPI) for each country being displayed on the map. The AML score may be obtained, for example, from the Basel AML index of the Basel Institute on Governance. The CPI may be obtained, for example, from the Anti-Corruption Research Network of Transparency International.

The result of displaying the three layers 110, 120 and 130 in FIG. 1 is that a user can, in just one place, and by using one application, superimpose data concerning a business entity on a map showing the country in which the business entity or portion thereof conducts business, with an overlay of the money laundering and corruption risks of doing business in that country. This allows the user to make informed decisions with respect to whether it is worth the risk of doing business with that business entity. For example, if the business is very sound, it may mitigate the risk of doing business in countries which are prone to money laundering or corruption. However, if the business entity that a user wishes to conduct business with is not a good risk, and is located in a county wherein money laundering and corruption are prevalent, as evidenced by poor evaluations under the relevant indices discussed above, a decision may be made to avoid doing business with or investing in that business entity.

Referring to FIG. 1A, at 140, CPI data for layer 130 is acquired, from an organization such as Transparancy.org and AML data is acquired at 150, from the Basel Institute on Governance, as discussed above. At 160, business data is acquired, as discussed above with respect to the second layer 120. At 170, the information acquired at 140, 150 and 160 is stored in a risk information repository. At 180, the Google Maps API is invoked to plot the risk information stored in the repository. At 190, the first layers 110, 120 and 130 are provided as an overlay on a user's browser.

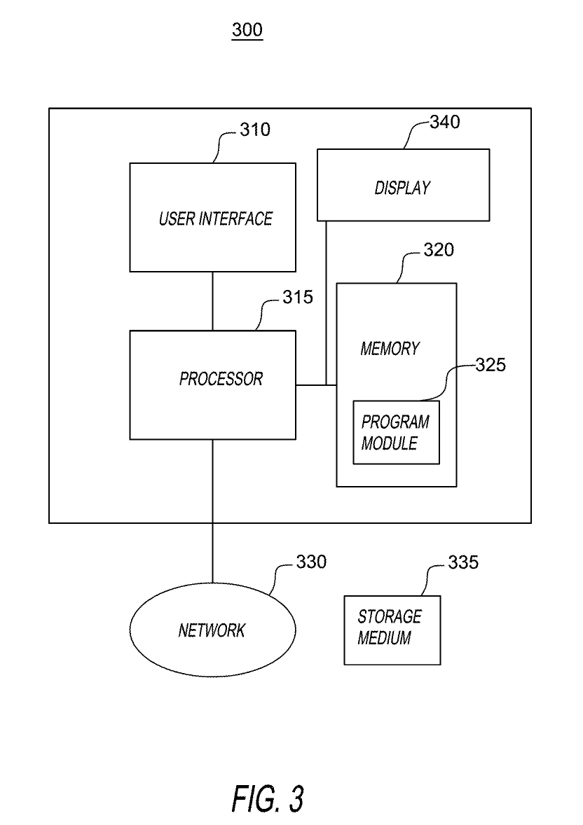

FIG. 1B is an example of a system architecture used to implement the method and system disclosed herein. A browser program 210, such as for example, Internet Explorer, associated with the computer of a user of the system, as described in FIG. 3 herein, provides a GUI 220 for display of map 100. Layer 110 is produced using world map data from world map server 230, such as, for example, a Google server. The Google Maps Javascript API can be used to render this layer using the data acquired. A core Google-maps API can be used. The system and method described herein call the Google-maps API to render a world map.

Data layer 120, including markers for the business entities as described below, is formed by acquiring data from a compliance data server 240 such as that of The Dun & Bradstreet Corporation. For a given business entity, latitude and longitude of the address of the entity is acquired if the address is in the format of country or state and country. If the entity has city level data, the address is acquired from server 240. The address is sent to server 230, which returns latitude and longitude for the address using the Google Geocode API, or other such technique. The Google Maps Marker API, or other such API, can be used to render this layer using the latitude and longitude data. Data boxes, as shown in FIGS. 2A and 2B, for the business entities are also generated using the data for the entities with the Google Maps InfoWindow API and placed using the Google Maps Marker API. Marker images are provided to the Google Maps Marker API to render layer 120. The Google Maps InfoWindow API can be used to display addresses of entities displayed in layer 120.

In general, there is an upper limit to the number of request per second for the Google Geocode API that is used to convert address to latitude and longitude. To avoid crossing this upper limit, latitude and longitude of all the countries, the Canadian provinces and the states of the United States are pre-calculated and stored. Most of the records have only country level address data or state level data. Subsequently, the Google Geocode API is called when more accurate address data, including street address is available, but only at regular time interval to avoid crossing the request per second limit, instead of calling for conversion of too much data at the same time.

Layer 130, a risk score overlay, is based on risk scores (AML and/or CPI), color and country boundary details obtained from server 240. The Google Maps Polygon API, or other similar API is used to render layer 130. The risk score for all the countries are retrieved. The color to be displayed for a country is calculated after comparing the score with a lower limit and an upper limit. The boundary and the color details are provided to the google-maps-polygon API. For example, if the color of the lower limit is red and the color of the upper limit is green, any score in between will have a proportional color mix of red and green. As an example, if the risk score is 70, the country will have a color made of a mix of 30% red and 70% green, which will be a greenish yellow color. The Google Maps InfoWindow API can be used to display risk scores associated with layer 130.

Alignment of features of first layer 110, second layer 120 and third layer 130 is important in allowing for easy interpretation of the display by a viewer. This is done by using the applications discussed above with respect to FIG. 1B, or other suitable computer techniques, based on the coordinates of the features obtained from the various sources, and aligning the features on a display, based on these coordinates.

Referring to FIG. 2A, an example of a geographic map 200 of the world (a Mercator projection in this example) produced in accordance with the disclosure is shown. As is typical of electronically generated maps, the scale can be adjusted by a slide bar 202. The point at the center of the map can be adjusted by using a position control 204. For a given selected business entity, the location of various components are displayed on map 200. Typical symbols (pins) for both legal entities and individuals are as follows: PE—parent entity, GU—global ultimate, DU—domestic ultimate, R—related entity, S—shareholder, and P—principal. The data on the business entity that is available is allocated on a country by country basis. By moving a cursor of a computer over a displayed symbol and hovering, a data box will appear on the map providing business information concerning that entity or individual of the types discussed above. In FIG. 2A, a user of the system has selected, via appropriate computer keyboard entry (FIG. 3), a particular business entity (HSBC). The GU (global ultimate) is based in London. In the United States, the PE (parent entity) is based in Mettawa in the United States.

In FIG. 2A, a third layer (FIG. 1, layer 130) overlay is present as superimposed colors on the map. These colors are keyed to various risk scores for the countries displayed as risk of money laundering. The overlay is selected by a drop down menu (not shown) for a particular year. Once a particular year has been selected, by placing a cursor over a country, the risk score associated with that country is displayed. As described above, by having data for a business entity, as well as data concerning risk of money laundering displayed as layers on a map, assistance is provided to a user to help the user determine the risk of doing business with that business in that country.

FIG. 2B is similar to FIG. 2A in most respects. However, the third layer (FIG. 1, layer 130) provides superimposed colors that are keyed to various risk scores for the countries displayed as risk of corruption. These colors are keyed to various risk scores for the countries displayed as risk of corruption in that country, in a manner similar to that discussed above with respect to money laundering in FIG. 2A.

In the preferred embodiment described herein, separate maps are generated to represent risk of money laundering (FIG. 2A) and risk of corruption (FIG. 2B). However, it is possible for two layers, preferably using different color schemes, to be superimposed on a second layer 120 (FIG. 1), so that both risk or money laundering and risk of corruption are simultaneously displayer along with relevant data with respect to a business entity or related components or individuals, thereof.

FIGS. 2A and 2B show data associated with the markers for, for example, the global ultimate GU, the parent entity PE, a subsidiary entity SE and a divisional unit DU. However, in one embodiment, the markers GU, PE, SE and DU are displayed without the associated data until a mouse over of the marker. When the user uses a mouse to move an indicator over the marker, the data is displayed.

The markers can be generated using a feature available with the Google Maps application program interface (API). The rendering of the map with markers thereon can be performed by Google maps. Once the map is drawn, the Marker API is called with input details including latitude, longitude, icon type etc. The API returns a marker object. With all the marker objects created, another feature is called to display the markers on the map.

FIG. 2C is a user interface 300 that can be provided for use with the displays of FIGS. 2A and 2B. User boxes that can be checked by placing a cursor over them (mouse-over) and clicking a mouse or other selection button include those for displaying principal 302, related parties 304, corporate linkage 306, all individuals and owners 308 and beneficial owner 310. When a large number of markers are displayed, the user can use a standard display tool to zoom in on a portion of the map. When there is street level data available, the various markers will be displayed in different locations. In any event, when an area is moused-over, as described above, data for all of the entities at that location is displayed.

The remainder of interface 300 includes a drop down menu 312 for selecting a year for anti-corruption data and a drop down menu 314 for selecting a year for anti-money laundering. If no year is selected, the country level risk overlay data is not displayed on the geographic heat map.

FIG. 3 is a block diagram of a computer system 300, for implementation of the present system and method. System 300 includes a computer 305 coupled to a network 310, e.g., the Internet.

Computer 305 includes a user interface 310, a processor 315, and a memory 320. Computer 305 may be implemented on a general-purpose microcomputer. User interface 310 will generally include a keyboard or a touch screen for entering user input. It is in this manner that particular business entities, and their associated components, can be selected for display in the second layer. A standard mouse can be used to activate drop down menus and make selection of choices therein.

Although computer 305 is represented herein as a standalone device, it is not limited to such, but instead can be coupled to other devices (not shown) via network 330.

Processor 315 is configured of logic circuitry that responds to and executes instructions.

Memory 320 stores data and instructions for controlling the operation of processor 315 to perform the functions, generate the displays and provide the display features discussed above. Memory 320 may be implemented in a random access memory (RAM), a hard drive, a read only memory (ROM), or a combination thereof. One of the components of memory 320 is a program module 325.

Program module 325 contains instructions for controlling processor 315 to execute the methods described herein. For example, as a result of execution of program module 325, processor 315 assembles data representative of general business risk for a plurality of business organizations to be displayed on the map, and superimposes on the map a map overlay representative of business risk due to at least one of corruption and money laundering in countries displayed on the map.

The term “module” is used herein to denote a functional operation that may be embodied either as a stand-alone component or as an integrated configuration of a plurality of sub-ordinate components. Thus, program module 325 may be implemented as a single module or as a plurality of modules that operate in cooperation with one another. Moreover, although program module 325 is described herein as being installed in memory 320, and therefore being implemented in software, it could be implemented in any of hardware (e.g., electronic circuitry), firmware, software, or a combination thereof.

User interface 310 includes an input device, such as a keyboard or speech recognition subsystem, for enabling a user to communicate information and command selections to processor 315. User interface 310 also includes an output device such as a display or a printer. A cursor control such as a mouse, track-ball, or joy stick, allows the user to manipulate a cursor on the display for communicating additional information and command selections to processor 315.

Processor 315 outputs, to user interface 310, a result of an execution of the methods described herein. Alternatively, processor 315 could direct the output to a remote device (not shown) via network 330. Access of computer 305 to the Internet and to a compliance check application, as described in U.S. patent application Ser. No. 14/026,843 (incorporated herein by reference), filed on Sep. 13, 2013, entitled Screening and Monitoring Data to Ensure that a Subject Entity Complies with Laws and Regulations, and assigned to the assignee of this application, is provided via network 330.

While program module 325 is indicated as already loaded into memory 320, it may be configured on a storage medium 335 for subsequent loading into memory 320. Storage medium 335 can be any conventional storage medium that stores program module 325 thereon in tangible form. Examples of storage medium 335 include a floppy disk, a compact disk, a magnetic tape, a read only memory, an optical storage media, universal serial bus (USB) flash drive, a digital versatile disc, or a zip drive. Alternatively, storage medium 335 can be a random access memory, or other type of electronic storage, located on a remote storage system and coupled to computer 305 via network 330.

System 300 includes a display 340 that is used to provide suitable GUI's for the performance of various tasks and to generate the maps of FIG. 2A and 2B described above.

Additional features that can be added to the system include links to adverse media presented on the map, direct linkage to content within the application from the geo heat map and the potential to support a multi-national global view of content based on upward company linkage.

It will be understood that the disclosure may be embodied in a computer readable non-transitory storage medium storing instructions of a computer program which when executed by a computer system results in performance of steps of the method described herein. Such storage media may include any of those mentioned in the description above.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A geographic heat map, comprising:
a first layer having a map of countries;
a second layer superimposed upon and in alignment with the first layer including locations of various entities on the map; and
a third layer superimposed on the second layer and in alignment with the first layer, the third layer having information concerning risk in the countries displayed in the first layer.

2. The geographic heat map of claim 1, wherein the entities displayed in the second layer include at least one of a business, principals, shareholders, related entities and corporate linkages of the business.

3. The geographic heat map of claim 2, further comprising a graphical user interface to allow a user to select a display of data representative of business risk for a business entity by one of principals, shareholders, related entities and corporate linkages.

4. The geographic heat map of claim 1, wherein the third layer is representative of risk in a given year, further comprising a graphical user interface for use in selecting which year is to be displayed.

5. The geographic heat map of claim 4, wherein the graphical user interface includes a drop down menu for selecting which year is to be displayed.

6. The geographic heat map of claim 1, wherein the third layer has features representative of business risk due to corruption in countries displayed on the map.

7. The geographic heat map of claim 1, wherein the third layer has features representative of business risk due to money laundering in countries displayed on the map.

8. The geographic heat map of claim 1, configured as a world map.

9. The geographic heat map of claim 1, including an interface for entering user preferences for the display generated on the heat map.

10. A display device configured for displaying a geographic heat map according to claim 1.

11. The display device of claim 10, connected to a computer, comprising:
a processor;
a memory for storing instructions for the processor to perform steps of:
assembling data representative of the first layer, the second layer and the third layer; and
converting the assembled data into the geographic heat map so that the map is placed on the display.

12. A method for generating a geographic heat map, comprising:
providing a first layer having a map of countries;
providing a second layer superimposed upon and in alignment with the first layer including locations of various entities on the map; and
providing a third layer superimposed on the second layer and in alignment with the first layer, the third layer having information concerning risk in the countries displayed in the first layer.

13. The method of claim 12, wherein the entities displayed in the second layer include at least one of a business, principals, shareholders, related entities and corporate linkages of the business.

14. The method of claim 13, wherein locations of the entities to be displayed in the second layer are determined by converting addresses of the entities to latitude and longitude coordinates.

15. The method of claim 14, wherein the latitude and longitude coordinates are those of a state within the United States, a province in Canada, and a country elsewhere.

16. The method of claim 13, further comprising providing a graphical user interface on the map to allow a user to select a display of data representative of business risk for a business entity by one of principals, shareholders, related entities and corporate linkages.

17. The method of claim 12, wherein the third layer is representative of risk in a given year, further comprising providing a graphical user interface for use in selecting which year is to be displayed.

18. The method of claim 17, wherein the graphical user interface includes a drop down menu for selecting which year is to be displayed.

19. The method of claim 12, wherein the third layer has features representative of business risk due to corruption in countries displayed on the map.

20. The method of claim 12, wherein the third layer has features representative of business risk due to money laundering in countries displayed on the map.

21. The method of claim 12, wherein the map is configured as a world map.

22. The method of claim 12, further comprising: entering, at a user interface associated with the heat map, user preferences for the display generated on the heat map.

23. A computer readable non-transitory storage medium storing instructions of a computer program which when executed by a computer system having a processor and a memory, results in performance of steps for providing a geographic heat map, comprising:
providing a first layer having a map of countries;
providing a second layer superimposed upon and in alignment with the first layer including locations of various entities on the map; and
providing a third layer superimposed on the second layer and in alignment with the first layer, the third layer having information concerning risk in the countries displayed in the first layer.

24. The computer readable non-transitory storage medium of claim 23, wherein the third layer has features representative of business risk due to corruption in countries displayed on the map.

25. The computer readable non-transitory storage medium of claim 23, wherein the third layer has features representative of business risk due to money laundering in countries displayed on the map.

26. A system for generating a geographic heat map, comprising:
a source for acquiring geographic data including data required to generate a map of countries;
a processor for generating a first layer of a display in accordance with the geographic data;
a source for acquiring entity data concerning entities and their locations with respect to said locations on said map;
the processor using the entity data to generate a second layer superimposed upon and in alignment with the first layer including locations of various entities on the map; and
a source for acquiring business risk data;
the processor generating a third layer superimposed on the second layer and in alignment with the first layer, the third layer using the business risk data to display information concerning risk in the countries displayed in the first layer.

27. The system of claim 26, wherein the source for acquiring geographic data comprises a server for serving the geographic data, and a connection for connecting the server to the system so that the geographic data is supplied by the server to the system.

28. The system of claim 26, wherein the source for acquiring entity data comprises a server for serving the entity data, and a connection for connecting the server to the system so that the entity data is supplied by the server to the system.

29. The system of claim 26, wherein the source for acquiring business risk data comprises a server for serving the business risk data, and a connection for connecting the server to the system so that the business risk data is supplied by the server to the system.

30. The system of claim 26, wherein the source for acquiring entity data and business risk data comprises a server for serving the entity data and the business risk data, and a connection for connecting the server to the system so that the entity data and the business risk data is supplied by the server to the system.

31. The system of claim 26, wherein the server is a single server for supplying the entity data and business risk data.
